(19) United States
(12) Patent Application Publication
(10) Pub. No.: US 2026/0299663 A1
(43) Pub. Date: Oct. 1, 2026

(54) ELECTRONIC DEVICE, CONTROL METHOD, AND STORAGE MEDIUM

(71) Applicant: CANON KABUSHIKI KAISHA, Tokyo (JP)

(72) Inventor: YASUHITO KIGURE, Tokyo (JP)

(21) Appl. No.: 19/567,580

(22) Filed: Mar. 16, 2026

(30) Foreign Application Priority Data
Mar. 25, 2025 (JP) 2025-050556

(51) Int. Cl. G06F 1/30; G06F 1/28

(52) U.S. Cl. CPC G06F 1/30; G06F 1/28

(57) ABSTRACT

In a case where a remaining amount of a battery is not greater than or equal to a predetermined amount, a control unit performs control such that a power source for a functional circuit is not switched from the battery to a first power supply apparatus even in a case where the first power supply apparatus is connected to a first connector in a situation where a second power supply apparatus is not connected to a second connector. The control unit performs control such that the power source is switched from the battery to the first power supply apparatus or the second power supply apparatus in a case where the first power supply apparatus is connected to the first connector and the second power supply apparatus is connected to the second connector.

### BACKGROUND

### Field of the Technology

The present disclosure relates to an electronic device, a control method, and a storage medium.

### Description of the Related Art

The Universal Serial Bus Power Delivery (USB PD) standard is a power supply standard that uses a connector and a cable that conform to the USB Type-C standard. In recent years, USB PD is widely used for power supply to such portable electronic devices as digital cameras and smartphones. The latest USB PD standard enables a supply of electric power of up to 240 W, and is adopted in electronic devices that require a large amount of electric power.

Meanwhile, the Type-C connector and cable come unplugged more easily than a general power source connector. Therefore, there is a possibility that the cable is unplugged unintentionally during USB PD power supply, and the power supply is thus interrupted. The occurrence of the unintentional interruption of a power source in an electronic device can possibly lead to a loss of data that is currently being processed.

International Publication No. 2020/129303 discloses a technique related to an image capturing apparatus including an electric power supply terminal that supplies electric power via a USB cable. With the image capturing apparatus of International Publication No. 2020/129303, operation of an image capturing unit is enabled by electric power from the electric power supply terminal in a case where a battery is attached thereto, and operation of the image capturing unit is not enabled by electric power from the electric power supply terminal in a case where a battery is not attached thereto.

With the image capturing apparatus of International Publication No. 2020/129303, operation of the image capturing unit is enabled by electric power from the electric power supply terminal in a case where a battery that is usable as a backup power source is attached thereto. Therefore, data loss can be prevented even if the power source is unintentionally interrupted due to unplugging of the USB cable. However, in a case where a battery is not attached, operation of the image capturing unit is not enabled even if sufficient electric power can be supplied via the USB cable, thereby impairing convenience for the user.

### SUMMARY

According to at least some aspects of the present disclosure, provided is a technique according to which, even in a situation where a battery is not available as a backup power source, if a plurality of power supply apparatuses are connected to an electronic device, a functional unit can be supplied with power from one of the power supply apparatuses.

According to one aspect of the present disclosure, there is provided an electronic device comprising: a first connector; a second connector; and at least one processor and/or at least one circuit which functions as: a selection unit configured to select a battery as a power source that supplies power to a functional circuit of the electronic device; and a control unit configured to, in a case where a first power supply apparatus is connected to the first connector in a situation where a second power supply apparatus is not connected to the second connector, control the selection unit to switch the power source from the battery to the first power supply apparatus, wherein in a case where a remaining amount of the battery is not greater than or equal to a predetermined amount, the control unit performs control such that the power source is not switched from the battery to the first power supply apparatus by the selection unit even in a case where the first power supply apparatus is connected to the first connector in a situation where the second power supply apparatus is not connected to the second connector, and the control unit performs control such that the power source is switched from the battery to the first power supply apparatus or the second power supply apparatus in a case where the first power supply apparatus is connected to the first connector and furthermore the second power supply apparatus is connected to the second connector.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram for describing exemplary connection between an electronic device 100 and power supply apparatuses 101 and 102.

FIG. 2 is a schematic configuration diagram of the electronic device 100.

FIG. 3 is a diagram for describing configurations of connection units 205 and 206, a battery 103, and a power source switching unit 207.

FIG. 4A is a flowchart of operations of the electronic device 100 according to a first embodiment.

FIG. 4B is a flowchart of operations of the electronic device 100 according to the first embodiment.

FIG. 4C is a flowchart of operations of the electronic device 100 according to the first embodiment.

FIG. 5A is a flowchart of operations of the electronic device 100 according to a second embodiment.

FIG. 5B is a flowchart of operations of the electronic device 100 according to the second embodiment.

FIG. 5C is a flowchart of operations of the electronic device 100 according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Exemplary Connection Between Electronic Device 100 and Power Supply Apparatuses 101 and 102

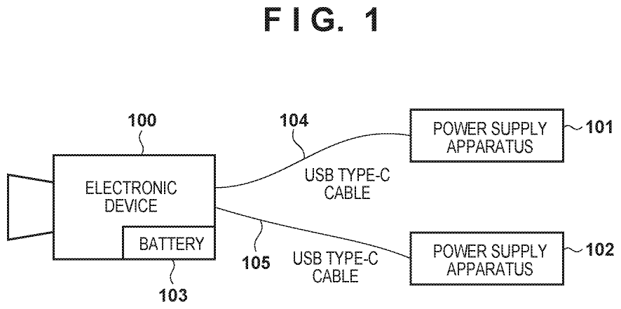

FIG. 1 is a schematic diagram for describing exemplary connection between an electronic device 100 and power supply apparatuses 101 and 102. The present embodiment will be described under the assumption that the electronic device 100 is an electronic device capable of operating as a digital video camera. However, the electronic device 100 is not limited to an electronic device capable of operating as a digital video camera, and may be an electronic device like a smartphone or a personal computer.

Also, the present embodiment will be described under the assumption that the power supply apparatuses 101 and 102 are power supply apparatuses capable of operating as power banks capable of supplying electric power with the USB PD. However, the power supply apparatuses 101 and 102 are not limited to power banks, and may be power supply apparatuses that connect to a commercial power source and supply electric power received from the commercial power source, or may be any type of power supply apparatuses capable of supplying electric power under any power supply standard, including the USB PD.

The electronic device 100 and the power supply apparatuses 101 and 102 include connectors (not shown) conforming to the USB Type-C standard. The electronic device 100 can connect to the power supply apparatuses 101 and 102 via USB Type-C cables 104 and 105.

The power supply apparatuses 101 and 102 conform to the USB PD standard, and can supply electric power to the electronic device 100 via the USB Type-C cables 104 and 105. The power supply apparatuses 101 and 102 supply electric power that is required for operation of the electronic device 100.

A battery 103 capable of supplying electric power that is required for operation of the electronic device 100 is attached to the electronic device 100. The battery 103 is a lithium-ion battery, and is accommodated inside a housing of the electronic device 100. The battery 103 is configured to be removable from the electronic device 100.

### Configuration of Electronic Device 100

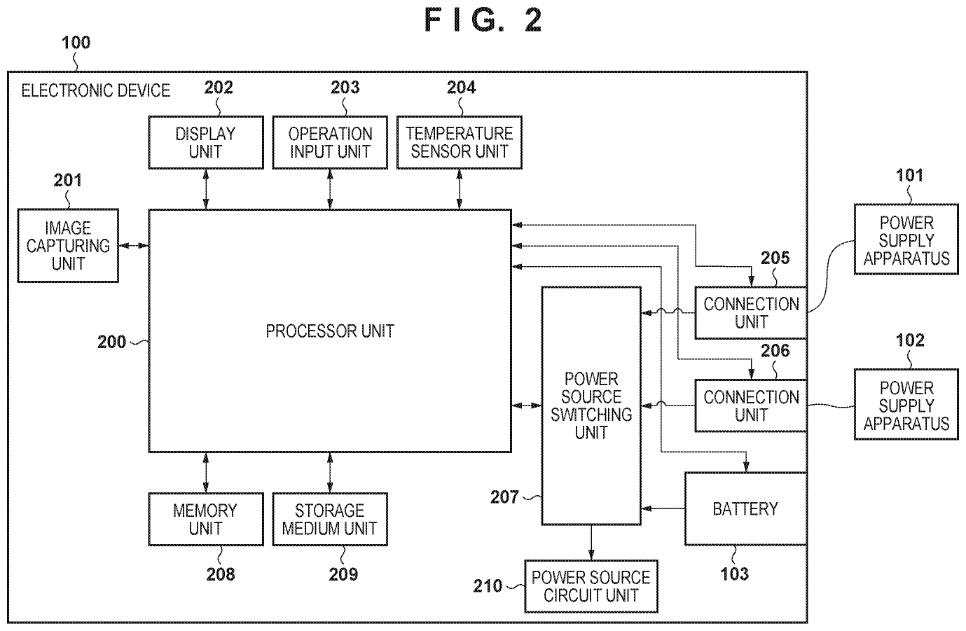

FIG. 2 is a schematic configuration diagram of the electronic device 100. The electronic device 100 includes a processor unit 200, an image capturing unit 201, a display unit 202, an operation input unit 203, a temperature sensor unit 204, a connection unit 205, a connection unit 206, a power source switching unit 207, a memory unit 208, a storage medium unit 209, and a power source circuit unit 210. Also, the electronic device 100 includes the battery 103 that is attachable to and removable from the electronic device 100.

The processor unit 200 executes various types of processing for input/output data and controls configuration blocks of the electronic device 100 by executing programs stored in the memory unit 208.

The image capturing unit 201 includes a lens unit and an image sensor, and generates image data from an optical image of a subject formed on an image plane of the image sensor via the lens unit. The processor unit 200 executes predetermined processing, such as image processing and encoding processing, with respect to the image data generated by the image capturing unit 201. The image data for which the predetermined processing has been executed is displayed on the display unit 202, or recorded into the storage medium unit 209, as shot data.

Under control of the processor unit 200, the display unit 202 displays shot data to enable a user to check a subject that is currently shot. Also, the display unit 202 reproduces and displays shot data stored in the storage medium unit 209, and displays various types of setting information of the electronic device 100.

The operation input unit 203 is a user interface that is intended for the user to operate the electronic device 100. The processor unit 200 executes various types of processing based on the user's operation input to the operation input unit 203.

The temperature sensor unit 204 detects a temperature of each configuration block of the electronic device 100. The processor unit 200 obtains a temperature detected by the temperature sensor unit 204 as temperature information, and executes various types of processing. For example, the processor unit 200 determines whether it is necessary to stop operation due to a temperature increase based on the difference between an upper limit operation temperature, which is stored in the memory unit 208 in advance, and the detected temperature. When the detected temperature has reached the upper limit operation temperature, the processor unit 200 stops operation of the electronic device 100.

In a case where the power supply apparatus 101 has been connected via the USB Type-C cable, the connection unit 205 receives electric power supplied from the power supply apparatus 101 in accordance with the USB PD standard. The connection unit 205 outputs a VBUS voltage supplied from the power supply apparatus 101 to the power source switching unit 207. The details of the configuration of the connection unit 205 will be described later. The connection unit 206 is configured in the same manner as the connection unit 205.

The battery 103 is a lithium-ion battery, and outputs a battery voltage to the power source switching unit 207. The details of the configuration of the battery 103 will be described later.

Under control of the processor unit 200, the power source switching unit 207 selects one of the respective VBUS voltages input from the connection units 205 and 206 and the battery voltage input from the battery 103, and outputs the selected voltage to the power source circuit unit 210.

The memory unit 208 is a memory that stores programs executed by the processor unit 200, and various types of information that are used in various types of processing in the processor unit 200. The memory unit 208 stores not only programs, but also, for example, reference data used in image processing, pieces of consumed electric power information for respective operation modes, operation mode information, image data for notifying the user of the state of the electronic device 100, and so forth.

The storage medium unit 209 is a storage medium that stores image data encoded by the processor unit 200; for example, an SD memory card or the like is used thereas.

The power source circuit unit 210 is a power source circuit that supplies power to each configuration block of the electronic device 100. The power source circuit unit 210 converts a voltage input from the power source switching unit 207 into a voltage required in each configuration block. The power source circuit unit 210 is provided with a plurality of power source circuits depending on a voltage value required in each configuration block.

### Configurations of Connection Units 205 and 206, Battery 103, and Power Source Switching Unit 207

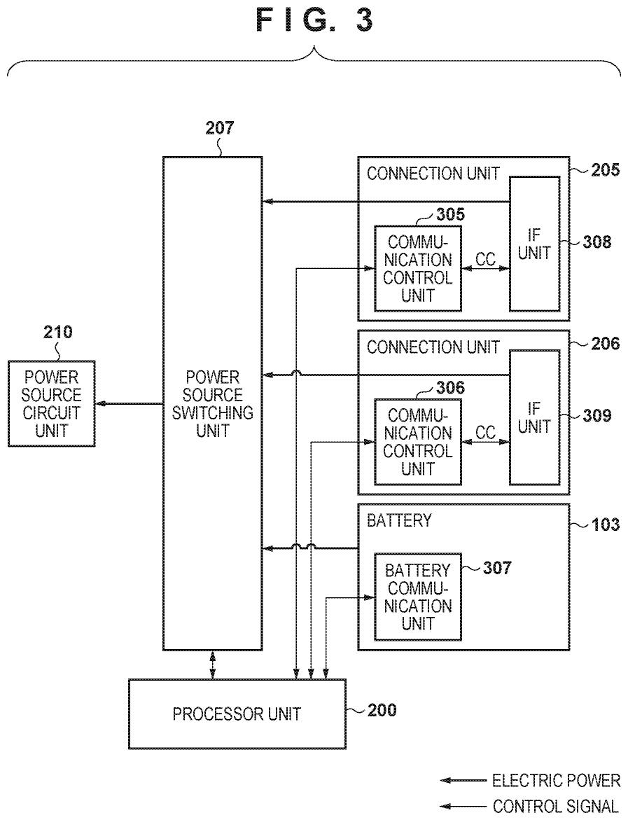

Next, the configurations of the connection units 205 and 206, the battery 103, and the power source switching unit 207 will be described with reference to FIG. 3.

The connection unit 205 includes an IF unit 308 and a communication control unit 305. Similarly to the connection unit 205, the connection unit 206 includes an IF unit 309 and a communication control unit 306. The battery 103 includes a battery communication unit 307 in addition to the lithium-ion battery.

The IF unit 308 is a connector conforming to the USB Type-C standard, and connects to the power supply apparatus 101 via the USB Type-C cable 104.

The communication control unit 305 is connected to a Configuration Channel (CC) terminal of the IF unit 308, and operates as a USB PD communication control circuit that performs communication conforming to the USB PD standard (hereinafter, CC communication). The communication control unit 305 detects connection of the power supply apparatus 101 in CC communication. Also, in CC communication, the communication control unit 305 detects a combination of voltage and current that can be supplied by the connected power supply apparatus 101, and notifies the processor unit 200 of the detection result.

The communication control unit 305 can perform a negotiation of power supply with the power supply apparatus 101 (hereinafter referred to as “power negotiation”). Under control of the processor unit 200, the communication control unit 305 performs the power negotiation with the connected power supply apparatus 101 so that desired power of a desired voltage is supplied from the power supply apparatus 101. The voltage input via a VBUS terminal of the IF unit 308 (hereinafter, a VBUS voltage) is output to the power source switching unit 207.

An IF unit 309 and a communication control unit 306 are configured in the same manner as the IF unit 308 and the communication control unit 305.

Under control of the processor unit 200, the battery communication unit 307 outputs information of a remaining battery amount of the lithium-ion battery to the processor unit 200. The battery 103 outputs a battery voltage to the power source switching unit 207. Note that the processor unit 200 may detect a remaining battery amount based on a discharge voltage of the battery 103, rather than information of a remaining battery amount from the battery communication unit 307.

As stated earlier, under control of the processor unit 200, the power source switching unit 207 selects one of the respective VBUS voltages input from the connection units 205 and 206 and the battery voltage input from the battery 103, and outputs the selected voltage to the power source circuit unit 210. Under an initial setting, the power source switching unit 207 selects the battery voltage input from the battery 103 and outputs the same to the power source circuit unit 210.

In a case where the remaining amount of the battery 103 is greater than or equal to a predetermined amount and the power supply apparatus connected to one of the IF units 308 and 309 is inputting the VBUS voltage after the power negotiation, the power source switching unit 207 switches the selected voltage from the battery voltage to the VBUS voltage, and outputs the VBUS voltage to the power source circuit unit 210. Meanwhile, in a case where the remaining amount of the battery 103 is not greater than or equal to the predetermined amount, the power source switching unit 207 does not switch from the battery voltage to the VBUS voltage under control of the processor unit 200.

In a case where the battery 103 is not attached to the electronic device 100, the processor unit 200 cannot communicate with the battery communication unit 307, and cannot obtain information of the remaining amount of the battery 103. Also, in a case where the battery 103 is not attached to the electronic device 100, the discharge voltage of the battery 103 detected by the processor unit 200 is 0 V. In a case where the processor unit 200 cannot communicate with the battery 103 or the discharge voltage of the battery 103 is 0 V in the foregoing manner, it is considered that the battery 103 is not attached to the electronic device 100. In a case where the remaining amount of the battery 103 is not greater than or equal to the predetermined amount, or in a case where the battery 103 is not attached to the electronic device 100, the power source switching unit 207 selects a VBUS voltage when the power supply apparatuses are connected to both of the IF units 308 and 309 and each power supply apparatus inputs a VBUS voltage after the power negotiation.

Also, in a case where two or more of the battery 103, the power supply apparatus 101, and the power supply apparatus 102 input a VBUS voltage, when a voltage supply from a power supply apparatus that is currently selected has been interrupted, the power source switching unit 207 selects a voltage from another power supply apparatus or the battery 103.

The interruption of the supply of electric power from the power supply apparatus 101 or the power supply apparatus 102 is presumed to be caused by discontinuation of connection to the power supply apparatus connected to the IF unit 308 or the IF unit 309. The power source switching unit 207 may detect the interruption of the supply of electric power via the communication control units 305 and 306. Alternatively, the power source switching unit 207 may be provided with a voltage detection circuit that detects the VBUS voltage of each power supply apparatus, and the power source switching unit 207 may detect the interruption of the supply of electric power from the power supply apparatus 101 or 102 when the VBUS voltage has become smaller than a predetermined reference voltage.

The processor unit 200 has two operation modes: a standby mode and a normal operation mode. When the battery 103 has been attached to the electronic device 100 or a power supply apparatus has been connected to one of the IF units 308 and 309, the power source switching unit 207 uses the power source circuit unit 210 to convert a battery voltage or a VBUS voltage (5 V) into a power source voltage (e.g., 3.3 V) required in the standby mode. The power source circuit unit 210 supplies electric power to the processor unit 200 at the post-conversion voltage. As a result, the processor unit 200 is activated in the standby mode.

The processor unit 200 can perform the aforementioned control of the communication control units 305 and 306, battery communication unit 307, and power source switching unit 207, as well as detection of inputting of a user operation to the operation input unit 203, also in the standby mode.

When the output of the power source circuit unit 210 has been input as a power source to each configuration block of the electronic device 100, the processor unit 200 is switched to the normal operation mode.

Note that in the foregoing description, it is assumed that the processor unit 200 performs the aforementioned control of the communication control units 305 and 306, battery communication unit 307, and power source switching unit 207, as well as detection of inputting of a user operation to the operation input unit 203. However, the electronic device 100 may include a different processor for performing such control and detection of inputting of a user operation, separately from the processor unit 200.

Note that in a case where the remaining amount of the battery 103 is not greater than or equal to the predetermined amount, or the battery 103 is not attached to the electronic device 100, when the power supply apparatuses have been connected to both of the IF units 308 and 309 and each power supply apparatus has input the VBUS voltage after the power negotiation, the VBUS voltage from one of the power supply apparatuses is selected and input to each configuration block of the electronic device 100. In this way, the processor unit 200 can operate in the normal operation mode. In a case where the supply of electric power has been interrupted due to, for example, unplugging of the USB Type-C cable that supplies the selected VBUS voltage while the processor unit 200 operates in the normal operation mode, the power source switching unit 207 switches the selected voltage to the VBUS voltage of the other power supply apparatus. In this case, the processor unit 200 may notify the user of the possibility that electric power may be interrupted.

### Operations of Electronic Device 100

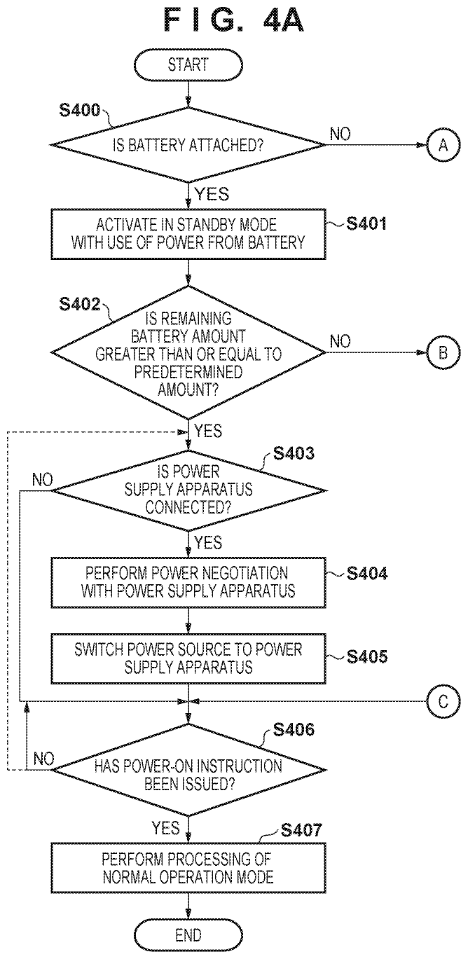

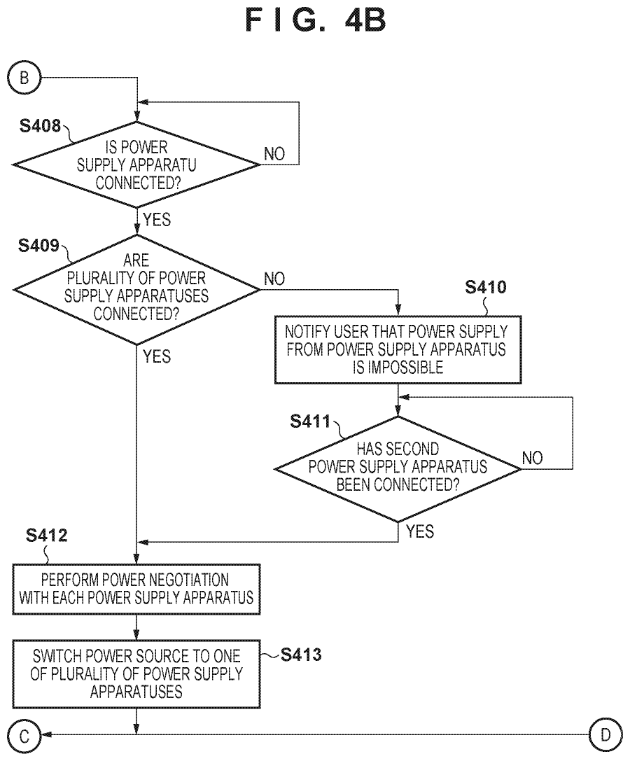

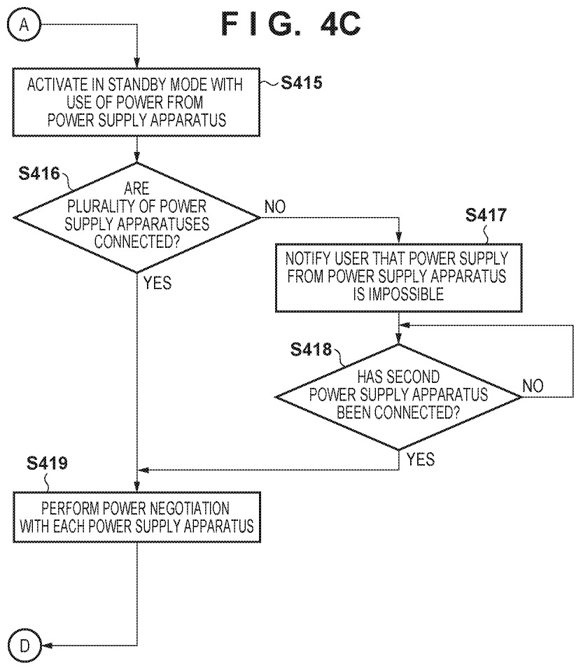

FIG. 4A to FIG. 4C are flowcharts of operations of the electronic device 100 according to the first embodiment. Processing of each step in the present flowcharts is realized by the processor unit 200 executing programs stored in the memory unit 208, unless specifically stated otherwise.

It is assumed that, before the present flowcharts are started, the battery 103 is not attached to the electronic device 100. Also, it is assumed that a power supply apparatus is connected to neither of the connection units 205 and 206 (to be more exact, the IF units 308 and 309). When the battery 103 has been attached to the electronic device 100, or a power supply apparatus has been connected to one of the connection units 205 and 206, a voltage is input to the power source switching unit 207. The power source switching unit 207 includes an internal processor (not shown), and this processor enables various types of processing and control to be executed; for example, this processor enables detection of inputting of a power source, and switching of a selected voltage to be input to the power source circuit unit 210. When the power source switching unit 207 has detected inputting of the voltage, processing of the present flowcharts is started.

Processing of step S400 is executed by the power source switching unit 207. At this point, the processor unit 200 is not activated. In step S400, the power source switching unit 207 determines whether the battery 103 is attached to the electronic device 100. The power source switching unit 207 detects that the battery 103 is attached based on, for example, the discharge voltage from the battery 103. For example, the power source switching unit 207 determines whether the discharge voltage of the battery 103 is larger than 0 V, and determines that the battery 103 is attached to the electronic device 100 in a case where the discharge voltage of the battery 103 is larger than 0 V. In a case where the battery 103 is attached (i.e., in a case where processing of the present flowcharts has been started in response to attachment of the battery 103 to the electronic device 100), processing proceeds to step S401. In a case where the battery 103 is not attached (i.e., in a case where processing of the present flowcharts has been started in response to connection of a power supply apparatus to one of the connection units 205 and 206), processing proceeds to step S415.

In step S401, the power source switching unit 207 performs control to supply a battery voltage input from the battery 103 to the processor unit 200 via the power source circuit unit 210. In other words, the power source switching unit 207 selects the battery 103 as a power source that supplies electric power to functional units (the processor unit 200, the image capturing unit 201, and the like) of the electronic device 100. Upon detecting inputting of the voltage, the processor unit 200 is activated in the standby mode with use of electric power from the battery 103.

In step S402, the processor unit 200 determines whether the remaining amount of the battery 103 is greater than or equal to a predetermined amount based on information of a remaining battery amount obtained from the battery communication unit 307. The predetermined amount is, for example, an amount equivalent to a remaining battery amount that enables a supply of electric power required for the electronic device 100 to operate in the normal operation mode. Alternatively, the predetermined amount may be an amount larger than a remaining battery amount that enables a supply of electric power required for the electronic device 100 to operate in the normal operation mode. In a case where the remaining amount of the battery 103 is greater than or equal to the predetermined amount, processing proceeds to step S403; otherwise, processing proceeds to step S408. Note that in step S402, the processor unit 200 may determine whether the discharge voltage of the battery 103 is greater than or equal to a predetermined voltage. In this case, the predetermined voltage is a voltage corresponding to a remaining battery amount that enables a supply of electric power required for the electronic device 100 to operate in the normal operation mode.

In step S403, the processor unit 200 determines whether a power supply apparatus is connected to one of the IF units 308 and 309. In a case where a power supply apparatus is connected to one of the IF units 308 and 309, processing proceeds to step S404; otherwise, processing proceeds to step S406.

In step S404, the processor unit 200 executes the power negotiation for enabling reception of electric power at a predetermined current and a predetermined voltage with the connected power supply apparatus (power supply apparatus 101 or power supply apparatus 102). In a case where one of the power supply apparatus 101 and the power supply apparatus 102 is connected, the power negotiation is performed via the communication control unit (communication control unit 305 or communication control unit 306) corresponding to the connected power supply apparatus. Also, in a case where both of the power supply apparatus 101 and the power supply apparatus 102 are connected, the power negotiation is performed with each of the power supply apparatuses 101 and 102 via the communication control units corresponding to both of the power supply apparatuses. In the power negotiation, the processor unit 200 receives, from the power supply apparatus, information (source capability) indicating one or more combinations of a voltage and a current that can be supplied by the power supply apparatus. The processor unit 200 selects a desired combination of a voltage and a current from among the one or more combinations of a voltage and a current indicated by the source capability, and requests the power supply apparatus for the selected voltage and current. The desired combination of a voltage and a current is a combination of a predetermined voltage and a predetermined current that enable a supply of electric power required for the electronic device 100 to operate in the normal operation mode, and is, for example, 15 V and 3 A (15 V×3 A=45 W).

In step S405, the processor unit 200 controls the power source switching unit 207 so that a selected voltage to be output from the power source switching unit 207 to the power source circuit unit 210 is switched from the battery voltage to a VBUS voltage of the power supply apparatus connected to one of the IF units 308 and 309 after the power negotiation. As a result, the power source for the functional units of the electronic device 100 is switched from the battery 103 to the power supply apparatus.

Note that in a case where the power supply apparatuses are connected to both of the IF units 308 and 309, the processor unit 200 may perform the power negotiation with each power supply apparatus in step S404. In this case, in step S405, the processor unit 200 performs control so that the voltage to be output from the power source switching unit 207 to the power source circuit unit 210 is switched to the VBUS voltage of one of the power supply apparatuses 101 and 102 connected to the IF units 308 and 309 (e.g., the power supply apparatus that was connected first) after the power negotiation. For example, the power supply apparatus that is selected as the power source here may be the power supply apparatus that was connected first, or may be the power supply apparatus 101 connected to the connection unit 205 regardless of the order of connection of the power supply apparatuses.

In step S406, the processor unit 200 determines whether a power-on instruction for the electronic device 100 has been issued through inputting of a user operation to the operation input unit 203. The processor unit 200 repeats the determination processing of step S406 until the power-on instruction is issued, and processing proceeds to step S407 when the power-on instruction has been issued.

Note that in a case where a power supply apparatus is connected to neither of the IF units 308 and 309, the processor unit 200 may cause processing to return to step S403 when it has been determined that the power-on instruction for the electronic device 100 has not been issued. In this case, even if processing has made a transition to step S406 after it has been determined that the power supply apparatus is not connected in step S403, processing of steps S404 and S405 is executed when the power supply apparatus has been connected to one of the IF units 308 and 309 before the power-on instruction is issued. As a result, the power source is switched from the battery 103 to the power supply apparatus before the power-on instruction is issued.

In step S407, the processor unit 200 executes activation processing in response to the power-on instruction for the electronic device 100, and starts operation in the normal operation mode. In a case where the remaining battery amount is greater than or equal to the predetermined amount, the power source that is used for operation in the normal operation mode is the battery 103 (in a case where processing of step S405 has not been executed), or the power supply apparatus connected to one of the IF units 308 and 309 (in a case where processing of step S405 has been executed). Also, in a case where the remaining battery amount is not greater than or equal to the predetermined amount and processing has proceeded by way of later-described step S411, one of the power supply apparatuses 101 and 102 connected to the IF units 308 and 309 is used as the power source. Furthermore, also in a case where the battery 103 is not attached and processing has proceeded by way of later-described step S417, one of the power supply apparatuses 101 and 102 connected to the IF units 308 and 309 is used as the power source.

In a case where it has been determined that the remaining battery amount is not greater than or equal to the predetermined amount in step S402, the processor unit 200 determines whether the power supply apparatus is connected to one of the IF units 308 and 309 in step S408. The processor unit 200 repeats the determination processing of step S408 until the power supply apparatus is connected to one of the IF units 308 and 309, and causes processing to proceed to step S409 when the power supply apparatus has been connected.

In step S409, the processor unit 200 determines whether a plurality of power supply apparatuses are connected to the electronic device 100 (i.e., whether the power supply apparatuses are connected to both of the IF units 308 and 309). In a case where the plurality of power supply apparatuses are connected, processing proceeds to step S412; otherwise, processing proceeds to step S410.

In step S410, the processor unit 200 provides a user with a notification indicating that the electronic device 100 cannot be activated by a power supply from the power supply apparatus. Although a method of providing the notification to the user is not limited in particular, one example is a notification method that uses a power source status lamp (not shown) arranged on an external covering of the electronic device 100. For example, in a case where the power source has already been activated, the processor unit 200 lights the power source status lamp in a specific color. On the other hand, in step S410, the processor unit 200 may light the power source status lamp in a color different from a color of a case where the power source has already been activated, or may cause the power source status lamp to flash in a color that is the same as a color of a case where the power source has already been activated.

In step S411, the processor unit 200 determines whether the second power supply apparatus has been connected to the electronic device 100 (i.e., whether a power supply apparatus has been newly connected to one of the IF units 308 and 309 to which a power supply apparatus was not connected). The processor unit 200 repeats the determination processing of step S411 until the second power supply apparatus is connected to the electronic device 100, and causes processing to proceed to step S412 when the second power supply apparatus has been connected.

In step S412, the processor unit 200 performs the power negotiation with each of the two power supply apparatuses (power supply apparatuses 101 and 102) connected to the electronic device 100. The details of the power negotiation with each power supply apparatus are similar to step S404.

In step S413, the processor unit 200 performs control so that the selected voltage to be output from the power source switching unit 207 to the power source circuit unit 210 is switched to the VBUS voltage of one of the power supply apparatuses 101 and 102 connected to the IF units 308 and 309 (e.g., the power supply apparatus that was connected first) after the power negotiation. For example, the power supply apparatus that is selected as the power source here may be the power supply apparatus that was connected first, or may be the power supply apparatus 101 connected to the connection unit 205 regardless of the order of connection of the power supply apparatuses. As a result, the power source is switched from the battery 103 to the power supply apparatus (power supply apparatus 101 or power supply apparatus 102). Thereafter, processing makes a transition to step S406. Note that even if the user has issued a power-on instruction from when it was determined that the remaining battery amount is not greater than or equal to the predetermined amount in step S402 to when the power negotiation is completed in step S412, the processor unit 200 does not execute processing for operation in the normal operation mode under the power-on instruction, and maintains the standby mode.

In a case where it has been determined that the battery 103 is not attached to the electronic device 100 in step S400, processing makes a transition to step S415. In this case, a power supply apparatus is connected to one of the IF units 308 and 309. At this point, the processor unit 200 is not activated. In step S415, the power source switching unit 207 performs control to supply a voltage input from the power supply apparatus connected to one of the IF units 308 and 309 to the processor unit 200 via the power source circuit unit 210. Upon detecting inputting of the voltage, the processor unit 200 is activated in the standby mode with use of electric power from the power supply apparatus.

Processing of steps S416 to S419 is similar to the aforementioned steps S409 to S412. Note that in a case where the battery 103 is not attached to the electronic device 100, the power source switching unit 207 has already selected a voltage of one of the power supply apparatus 101 and the power supply apparatus 102 as a voltage to be output to the power source circuit unit 210 at the time of step S415. For this reason, following step S419, the processor unit 200 need not execute processing corresponding to step S413. Therefore, processing makes a transition from step S419 to step S406. Also, even if the user has issued a power-on instruction from when it was determined that the battery 103 is not attached in step S400 to when the power negotiation is completed in step S419, the processor unit 200 does not execute processing for operation in the normal operation mode under the power-on instruction, and maintains the standby mode.

In the normal operation mode of step S407, in a case where connection between the power supply apparatus used as the power source and the electronic device 100 is disconnected in a state where one of the power supply apparatuses 101 and 102 connected to the IF units 308 and 309 is used as the power source, the processor unit 200 controls the power source switching unit 207 to switch the power source of the electronic device 100 to the battery 103 or the other power supply apparatus.

For example, in a case where one of the power supply apparatus 101 and the power supply apparatus 102 is connected and the power source was switched from the battery 103 to the power supply apparatus in step S405, if connection of the power supply apparatus is disconnected, the processor unit 200 controls the power source switching unit 207 to use the battery 103 as the power source. In this case, the battery 103 is selected as the power source of the electronic device 100, and processing of the normal operation mode is continued. If connection of the power supply apparatus that is currently used as the power source is disconnected, the battery 103 is used as a backup power source. Then, when the user has issued a power-off instruction, the processor unit 200 is placed in the standby mode, and processing is repeated from step S400 of FIG. 4.

Note that in a case where both of the power supply apparatuses 101 and 102 are connected and the power source was switched from the battery 103 to one of the power supply apparatuses 101 and 102 in step S405, if connection of this power supply apparatus is disconnected, the processor unit 200 may select the other power supply apparatus as the power source of the electronic device 100.

Also, in a case where one of the power supply apparatuses 101 and 102 was selected as the power source in step S413 or S419 and connection of the selected power supply apparatus is disconnected, the processor unit 200 controls the power source switching unit 207 to use the other power supply apparatus as the power source. In this case, one of the power supply apparatuses 101 and 102 is selected as the power source and processing of the normal operation mode is continued in a state where the remaining amount of the battery 103 is not greater than or equal to the predetermined amount or the battery 103 is not attached. If connection of one of the power supply apparatuses 101 and 102 that was selected as the power source is disconnected in the normal operation mode, the other power supply apparatus is used as the backup power source. Then, when the user has issued a power-off instruction, the processor unit 200 is placed in the standby mode, and processing is repeated from step S400 of FIG. 4.

As described above, according to the first embodiment, the electronic device 100 includes functional units (the processor unit 200, the image capturing unit 201, and the like) that are powered by electric power supplied from the battery 103, the power supply apparatus 101 (an external first power supply apparatus), or the power supply apparatus 102 (an external second power supply apparatus). The electronic device 100 also includes the connection unit 205 (a first connection unit) connectable to the power supply apparatus 101, and a connection unit 206 (a second connection unit) connectable to the power supply apparatus 102. In a case where the power supply apparatus 101 has been connected to the connection unit 205 in a situation where the battery 103 has been selected as a power source that supplies electric power to the functional units (step S401) and the power supply apparatus 102 is not connected to the connection unit 206, the electronic device 100 performs control to switch the power source for the functional units from the battery 103 to the power supply apparatus 101 (step S405). Then, it executes processing for operation in the normal operation mode in response to a user's power-on instruction. However, in a case where the remaining amount of the battery 103 is not greater than or equal to the predetermined amount, the electronic device 100 refrains from performing control to switch the power source for the functional units from the battery 103 to the power supply apparatus 101, even when the power supply apparatus 101 has been connected to the connection unit 205 in a situation where the power supply apparatus 102 is not connected to the connection unit 206 (step S410). Then, even if a user has issued a power-on instruction, it does not execute processing for operation in the normal operation mode. Furthermore, in a case where the remaining amount of the battery 103 is not greater than or equal to the predetermined amount, when the power supply apparatus 101 and the power supply apparatus 102 have been respectively connected to the connection unit 205 and the connection unit 206, the electronic device 100 performs control to switch the power source for the functional units from the battery 103 to the power supply apparatus 101 or the power supply apparatus 102 (step S413). Then, it executes processing for operation in the normal operation mode in response to a user's power-on instruction.

In the foregoing manner, in the present embodiment, even in a situation where the remaining amount of the battery 103 is not greater than or equal to the predetermined amount (the battery 103 is not usable as the backup power source), electric power can be supplied from a power supply apparatus to the functional units by the user connecting a plurality of power supply apparatuses (power supply apparatus 101 and power supply apparatus 102) to the electronic device 100. Therefore, according to the present embodiment, convenience for the user can be improved while lowering the possibility of the occurrence of a data loss in a case where a power supply apparatus is unintentionally disconnected.

Note that there may be a case where the user has taken sufficient measures against unplugging of the USB Type-C cables, and a case where the user can tolerate a data loss caused by the interruption of the power source. In such cases, even when the remaining amount of the battery 103 is smaller than the predetermined amount and only one power supply apparatus is connected to the electronic device 100, there is a possibility that the user wishes to supply electric power from the power supply apparatus to the functional units. In view of this, the electronic device 100 may be configured to, even when the remaining amount of the battery 103 is smaller than the predetermined amount and only one power supply apparatus is connected to the electronic device 100, perform control to switch the power source from the battery to the power supply apparatus in a case where the user has issued a predetermined instruction.

### Second Embodiment

In the first embodiment, it is assumed that a power supply apparatus capable of supplying a combination of a predetermined voltage and a predetermined current requested by the electronic device 100 is connected and the power negotiation with the power supply apparatus is completed. However, the combination of a voltage and a current that can be supplied varies depending on a power supply apparatus. Therefore, there is a case where a power supply apparatus that cannot supply a combination of a predetermined voltage and a predetermined current requested by the electronic device 100 is connected, and the power negotiation with the power supply apparatus is not completed (the power negotiation fails). In a case where the remaining amount of the battery 103 is not greater than or equal to the predetermined amount, even if a plurality of power supply apparatuses have been connected to the electronic device 100, the possibility of a data loss caused by the unintentional interruption of the power source cannot be sufficiently lowered when the power negotiation has succeeded only with one power supply apparatus.

In view of this, a second embodiment will be described in relation to a configuration for addressing a case where the power negotiation has failed. In the present embodiment, a basic configuration of the electronic device 100 is similar to that of the first embodiment. The following mainly describes the differences from the first embodiment.

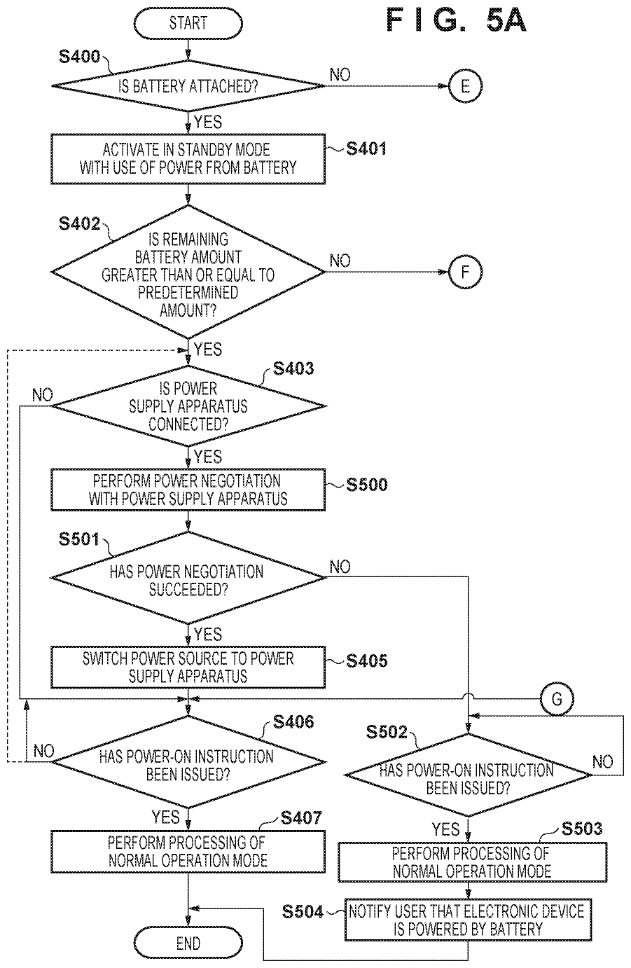

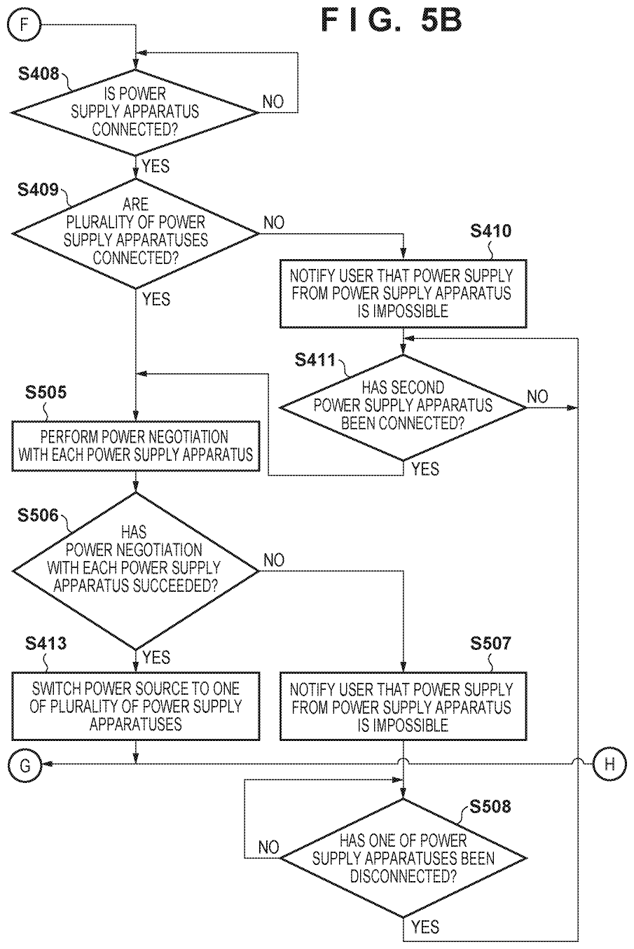

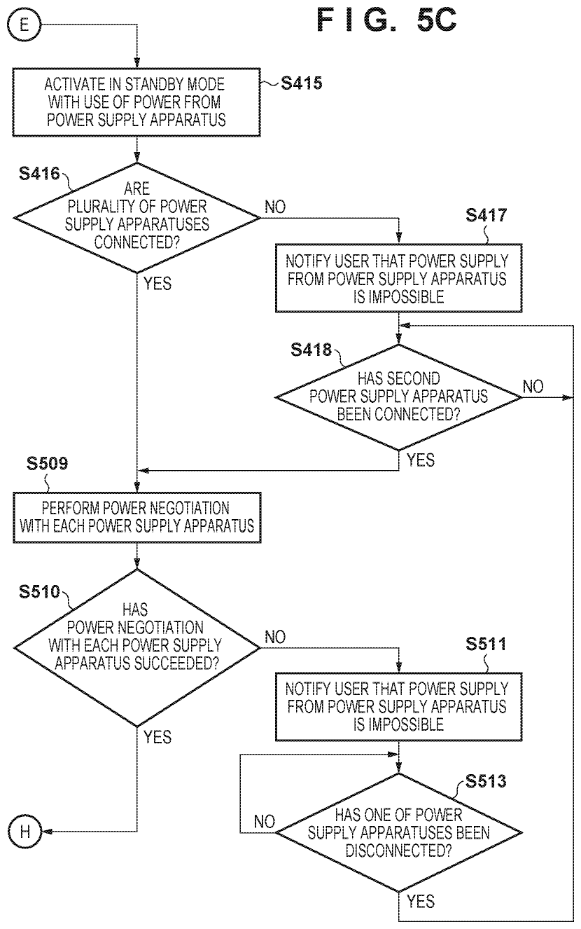

FIG. 5A to FIG. 5C are flowcharts of operations of the electronic device 100 according to the second embodiment. Processing of each step in the present flowcharts is realized by the processor unit 200 executing programs stored in the memory unit 208, unless specifically stated otherwise.

In step S500, the processor unit 200 performs the power negotiation with the connected power supply apparatus (power supply apparatus 101 or power supply apparatus 102), similarly to step S404 of FIG. 4A. In a case where information (source capability) indicating one or more combinations of a voltage and a current that can be supplied, which is received from the power supply apparatus, includes a combination of a predetermined voltage and a predetermined current requested by the electronic device 100, the power negotiation succeeds (is completed normally) through processing described in step S404 of FIG. 4A. On the other hand, in a case where this information (source capability) does not include the combination of the predetermined voltage and the predetermined current requested by the electronic device 100, the power negotiation fails.

In step S501, the processor unit 200 determines whether the power negotiation has succeeded. In a case where the power negotiation has succeeded, processing proceeds to step S405; in a case where the power negotiation has failed, processing proceeds to step S502.

In step S502, the processor unit 200 determines whether a power-on instruction for the electronic device 100 has been issued through inputting of a user operation to the operation input unit 203, similarly to step S406 of FIG. 4A. The processor unit 200 repeats the determination processing of step S502 until the power-on instruction is issued, and causes processing to proceed to step S503 when the power-on instruction has been issued.

In step S503, the processor unit 200 executes activation processing in response to the power-on instruction for the electronic device 100, and starts operation in the normal operation mode.

In step S504, the processor unit 200 provides the user with a notification indicating that electric power cannot be supplied from the connected power supply apparatus, and that the electronic device 100 operates using electric power from the battery. Although a notification method is not limited in particular, the processor unit 200 can, for example, display the content of the notification on the display unit 202.

In step S505, the processor unit 200 performs the power negotiation with each of the two power supply apparatuses connected to the electronic device 100 (power supply apparatuses 101 and 102), similarly to step S412 of FIG. 4B. The details of the power negotiation with each power supply apparatus are similar to step S404 of FIG. 4A. Also, the success and failure of the power negotiation are as described in step S500.

In step S506, the processor unit 200 determines whether the power negotiation has succeeded with each power supply apparatus (the power supply apparatuses 101 and 102). In a case where the power negotiation has succeeded with each power supply apparatus (both of the two power supply apparatuses), processing proceeds to step S413. In a case where the power negotiation has failed with at least one of the two power supply apparatuses, processing proceeds to step S507.

In step S507, the processor unit 200 provides the user with a notification indicating that the power source of the electronic device 100 cannot be activated by a power supply from the power supply apparatuses. Although a method of providing the notification to the user is not limited in particular, the processor unit 200 may provide the notification with use of, for example, a power source status lamp (not shown) arranged on an external covering of the electronic device 100, similarly to step S410 of FIG. 4B. Also, the processor unit 200 may provide the user with a notification indicating that the power negotiation has failed by causing the power source status lamp to emit light in a lighting pattern different from that of the case of step S410. Furthermore, the processor unit 200 may use different lighting patterns between a case where the power negotiation has failed with both of the two power supply apparatuses and a case where the power negotiation has failed with one of the two power supply apparatuses.

In step S508, the processor unit 200 determines whether one of the power supply apparatuses connected to the electronic device 100 (the power supply apparatuses 101 and 102) has been disconnected. The processor unit 200 repeats the determination processing of step S508 until one of the power supply apparatuses connected to the electronic device 100 (the power supply apparatuses 101 and 102) is disconnected, and causes processing to return to step S411 when one of the power supply apparatuses is disconnected.

Processing of steps S509 to S512 is similar to the aforementioned steps S505 to S508.

As described above, in a case where the remaining amount of the battery 103 is smaller than the predetermined amount, the second embodiment refrains from performing control to switch the power source from the battery 103 to the power supply apparatus 101 or the power supply apparatus 102 when the power negotiation has failed with at least one of the power supply apparatus 101 (external first power supply apparatus) and the power supply apparatus 102 (external second power supply apparatus) that are connected to the electronic device 100 (step S507).

Therefore, the second embodiment can lower the possibility of a data loss caused by the unintentional interruption of electric power while ensuring convenience for the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)¹⁹⁸ ), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-050556, filed Mar. 25, 2025, which is hereby incorporated by reference herein in its entirety.

What is claimed is:

1. An electronic device comprising:
a first connector;
a second connector; and
at least one processor and/or at least one circuit which functions as:
a selection unit configured to select a battery as a power source that supplies power to a functional circuit of the electronic device; and
a control unit configured to, in a case where a first power supply apparatus is connected to the first connector in a situation where a second power supply apparatus is not connected to the second connector, control the selection unit to switch the power source from the battery to the first power supply apparatus,
wherein in a case where a remaining amount of the battery is not greater than or equal to a predetermined amount,
the control unit performs control such that the power source is not switched from the battery to the first power supply apparatus by the selection unit even in a case where the first power supply apparatus is connected to the first connector in a situation where the second power supply apparatus is not connected to the second connector, and
the control unit performs control such that the power source is switched from the battery to the first power supply apparatus or the second power supply apparatus in a case where the first power supply apparatus is connected to the first connector and furthermore the second power supply apparatus is connected to the second connector.

2. The electronic device according to claim 1, wherein
in a case where the remaining amount of the battery is not greater than or equal to the predetermined amount, furthermore the first power supply apparatus is connected to the first connector, and furthermore the second power supply apparatus is connected to the second connector, the control unit performs control to execute power negotiation with each of the first power supply apparatus and the second power supply apparatus, for enabling reception of power at a predetermined current and a predetermined voltage.

3. The electronic device according to claim 2, wherein
in a case where the remaining amount of the battery is not greater than or equal to the predetermined amount and the power negotiation with at least one of the first power supply apparatus and the second power supply apparatus failed, the control unit controls the selection unit not to switch the power source from the battery to the first power supply apparatus and the second power supply apparatus.

4. The electronic device according to claim 1, wherein
the battery is attachable to and removable from the electronic device,
in a case where the battery is not attached to the electronic device,
the selection unit selects the first power supply apparatus as the power source in a case where the first power supply apparatus is connected to the first connector in a situation where the second power supply apparatus is not connected to the second connector, and
after the first power supply apparatus is selected as the power source,
the control unit performs control to execute power negotiation with each of the first power supply apparatus and the second power supply apparatus, for enabling reception of power at a predetermined current and a predetermined voltage in a case where the second power supply apparatus is connected to the second connector, and
the control unit performs control so as not to execute the power negotiation with the first power supply apparatus in a case where the second power supply apparatus is not connected to the second connector.

5. The electronic device according to claim 1, wherein
in a case where the remaining amount of the battery is not greater than or equal to the predetermined amount,
if one of the first power supply apparatus and the second power supply apparatus is disconnected while the first power supply apparatus is connected to the first connector, furthermore the second power supply apparatus is connected to the second connector, and furthermore the one of the first power supply apparatus and the second power supply apparatus is supplying power to the functional circuit as the power source,
the selection unit switches the power source from the one of first power supply apparatus and the second power supply apparatus to another of the first power supply apparatus and the second power supply apparatus.

6. The electronic device according to claim 1, wherein
in a case where the first power supply apparatus is disconnected while the second power supply apparatus is not connected to the second connector and furthermore the first power supply apparatus is supplying power to the functional circuit as the power source, the selection unit switches the power source from the first power supply apparatus to the battery.

7. The electronic device according to claim 1, wherein
even in a case where the remaining amount of the battery is not greater than or equal to the predetermined amount and furthermore the first power supply apparatus is connected to the first connector in a situation where the second power supply apparatus is not connected to the second connector, the control unit controls the selection unit to switch the power source from the battery to the first power supply apparatus if a predetermined instruction is issued by a user.

8. The electronic device according to claim 1, wherein
the control unit performs control to, in response to a power-on instruction, perform an operation in a normal operation mode by supplying power from the power source selected by the selection unit to the functional circuit, and
in a case where the remaining amount of the battery is not greater than or equal to the predetermined amount, furthermore the power source is switched from the battery to the first power supply apparatus out of the first power supply apparatus connected to the first connector and the second power supply apparatus connected to the second connector, and furthermore the connection between the first power supply apparatus and the first connector is disconnected while performing the operation in the normal operation mode using power from the first power supply apparatus, the control unit controls the selection unit to switch the power source to the second power supply apparatus connected to the second connector.

9. The electronic device according to claim 1, wherein
the first power supply apparatus is connected to the first connector via a first USB Type-C cable, and
the second power supply apparatus is connected to the second connector via a second USB Type-C cable.

10. The electronic device according to claim 1, wherein
the first connector and the second connector conform to a USB Power Delivery standard.

11. The electronic device according to claim 1, wherein the electronic device includes at least one of a video camera, a smartphone and a personal computer.

12. The electronic device according to claim 1, wherein the first power supply apparatus and the second power supply apparatus include at least one of a power bank and a power supply apparatus that connects to a commercial power source and supplies power received from the commercial power source.

13. A control method executed by an electronic device,
the control method comprising:
selecting a battery as a power source that supplies power to a functional circuit of the electronic device; and
in a case where a first power supply apparatus is connected to a first connector of the electronic device in a situation where a second power supply apparatus is not connected to a second connector of the electronic device, controlling to switch the power source from the battery to the first power supply apparatus,
wherein in a case where a remaining amount of the battery is not greater than or equal to a predetermined amount,
the control method performs control such that the power source is not switched from the battery to the first power supply apparatus even in a case where the first power supply apparatus is connected to the first connector in a situation where the second power supply apparatus is not connected to the second connector, and
the control method performs control such that the power source is switched from the battery to the first power supply apparatus or the second power supply apparatus in a case where the first power supply apparatus is connected to the first connector and furthermore the second power supply apparatus is connected to the second connector.

14. A non-transitory computer-readable storage medium which stores a program for causing an electronic device to execute a control method,
the control method comprising:
selecting a battery as a power source that supplies power to a functional circuit of the electronic device; and
in a case where a first power supply apparatus is connected to a first connector of the electronic device in a situation where a second power supply apparatus is not connected to a second connector of the electronic device, controlling to switch the power source from the battery to the first power supply apparatus,
wherein in a case where a remaining amount of the battery is not greater than or equal to a predetermined amount,
the control method performs control such that the power source is not switched from the battery to the first power supply apparatus even in a case where the first power supply apparatus is connected to the first connector in a situation where the second power supply apparatus is not connected to the second connector, and
the control method performs control such that the power source is switched from the battery to the first power supply apparatus or the second power supply apparatus in a case where the first power supply apparatus is connected to the first connector and furthermore the second power supply apparatus is connected to the second connector.
